(19) United States
(12) Patent Application Publication
(10) Pub. No.: US 2026/0153768 A1
(43) Pub. Date: Jun. 4, 2026

(54) DISPLAY DEVICE

(71) Applicant: Japan Display Inc., Tokyo (JP)

(72) Inventors: Koichi IGETA, Tokyo (JP); Shinichiro OKA, Tokyo (JP); Junji KOBASHI, Tokyo (JP)

(73) Assignee: Japan Display Inc., Tokyo (JP)

(21) Appl. No.: 19/405,562

(22) Filed: Dec. 2, 2025

(30) Foreign Application Priority Data
Dec. 3, 2024 (JP) 2024-210519

(51) Int. Cl. G02F 1/1335; G02F 1/137

(52) U.S. Cl. CPC G02F 1/133553; G02F 1/13718

(57) ABSTRACT

According to one embodiment, a display device includes a transparent substrate having a first main surface and a second main surface, a display element, a first optical element facing the display element, and a second optical element spaced apart from the first optical element. Each of the first optical element and the second optical element includes a first liquid crystal layer containing a first cholesteric liquid crystal and a second liquid crystal layer containing a second cholesteric liquid crystal. The second liquid crystal layer overlaps the first liquid crystal layer in the first optical element. In the second optical element, the first liquid crystal layer and the second liquid crystal layer are arranged on the second main surface.

### CROSS-REFERENCE TO RELATED APPLICATIONS

This application is based upon and claims the benefit of priority from Japanese Patent Application No. 2024-210519, filed Dec. 3, 2024, the entire contents of which are incorporated herein by reference.

### FIELD

Embodiments described herein relate generally to a display device.

### BACKGROUND

Recently, various types of head-mounted displays using a holographic optical element (which may be hereinafter simply referred to as an HOE) which diffracts display light from a display element and a light guide have been considered. For example, a technique which provides a holographic diffractive optical element on each surface of the light guide is known. The HOE provided on one surface of the light guide diffracts display light so as to be totally reflected at the light guide. The HOE provided on the other surface of the light guide diffracts display light which propagates inside the light guide so as to be emitted to the outside.

When this head-mounted display has a narrow observation area for displaying images, the positions of the eyes of the user and the observation area tend to be misaligned. In this case, the visibility of images for the user is reduced.

### BRIEF DESCRIPTION OF THE DRAWINGS

FIG. 1 is a view showing a configuration example of a display device DSP.

FIG. 2 is a view for describing a first optical element 10 of the display device DSP shown in FIG. 1.

FIG. 3 is a view for describing a liquid crystal layer 21 of a second optical element 20 of the display device DSP shown in FIG. 1.

FIG. 4 is a view for describing a liquid crystal layer 22 of the second optical element 20 of the display device DSP shown in FIG. 1.

FIG. 5 is a view for describing reflective surfaces 11R and 12R in the first optical element 10 shown in FIG. 1.

FIG. 6 is a cross-sectional view for describing an example of a cholesteric liquid crystal CL1 contained in a liquid crystal layer 11 and a cholesteric liquid crystal CL2 contained in a liquid crystal layer 12 shown in FIG. 5.

FIG. 7 is a plan view schematically showing the liquid crystal layer 11 shown in FIG. 5.

FIG. 8 is a plan view schematically showing the liquid crystal layer 12 shown in FIG. 5.

FIG. 9 is a view for describing reflective surfaces 21R and 22R in the second optical element 20 shown in FIG. 1.

FIG. 10 is a plan view showing an example of an image displayed in the display device DSP shown in FIG. 1.

FIG. 11 is a view showing another configuration example of the display device DSP.

FIG. 12 is a view for describing liquid crystal layers 211 and 212 of the display device DSP shown in FIG. 11.

FIG. 13 is a view for describing liquid crystal layers 221 and 222 of the display device DSP shown in FIG. 11.

FIG. 14 is a plan view showing an example of an image displayed in the display device DSP shown in FIG. 11.

FIG. 15 is a view showing another configuration example of the display device DSP.

FIG. 16 is a view for describing the reflective surfaces 11R and 12R in the first optical element 10 shown in FIG. 15.

FIG. 17 is a view for describing the reflective surfaces 21R and 22R in the second optical element 20 shown in FIG. 15.

FIG. 18 is a plan view showing an example of an image displayed in the display device DSP shown in FIG. 15.

FIG. 19 is a view showing another configuration example of the display device DSP.

FIG. 20 is a plan view showing an example of an image displayed in the display device DSP shown in FIG. 19.

FIG. 21 is a view showing another configuration example of the display device DSP.

FIG. 22 is a view for describing the first optical element 10 of the display device DSP shown in FIG. 21.

FIG. 23 is a view for describing a first stacked layer body 20A of the display device DSP shown in FIG. 21.

FIG. 24 is a view for describing a second stacked layer body 20B of the display device DSP shown in FIG. 21.

### DETAILED DESCRIPTION

In general, according to one embodiment, a display device includes a transparent substrate having a first main surface and a second main surface on a side opposite to the first main surface, a display element facing the first main surface and configured to emit display light toward the transparent substrate, a first optical element facing the display element via the transparent substrate, provided on the second main surface, and configured to reflect the display light having passed through the transparent substrate, and a second optical element spaced apart from the first optical element, provided on the second main surface, and configured to reflect the display light having propagated inside the transparent substrate. Each of the first optical element and the second optical element includes a first liquid crystal layer containing a first cholesteric liquid crystal and a second liquid crystal layer containing a second cholesteric liquid crystal twisted in an opposite direction to the first cholesteric liquid crystal. The second liquid crystal layer overlaps the first liquid crystal layer in the first optical element. In the second optical element, the first liquid crystal layer and the second liquid crystal layer are arranged on the second main surface.

Embodiments will be described hereinafter with reference to the accompanying drawings.

The disclosure is merely an example, and proper changes in keeping with the spirit of the disclosure, which are easily conceivable by a person of ordinary skill in the art, come within the scope of the disclosure as a matter of course. In addition, in some cases, in order to make the description clearer, the widths, thicknesses, shapes, etc., of the respective parts are illustrated schematically in the drawings, rather than as an accurate representation of what is implemented. However, such schematic illustration is merely exemplary, and in no way restricts the interpretation of the disclosure. In addition, in the specification and drawings, structural elements which function in the same or a similar manner to those described in connection with preceding drawings are denoted by like reference numbers, detailed description thereof being omitted unless necessary.

In the figures, an X-axis, a Y-axis, and a Z-axis orthogonal to each other are described to facilitate understanding as needed. A direction parallel to the X-axis is referred to as a first direction X. A direction parallel to the Y-axis is referred to as a second direction Y. A direction parallel to the Z-axis is referred to as a third direction Z. A plane defined by the first direction X and the second direction Y is referred to as an X-Y plane. A plane defined by the second direction Y and the third direction Z is referred to as a Y-Z plane. A plane defined by the first direction X and the third direction Z is referred to as an X-Z plane. A plan view is defined as appearance when various types of elements are viewed parallel to the third direction Z. When terms indicating the positional relationships of two or more structural elements, such as “on”, “above” “between” and “face”, are used, the target structural elements may be directly in contact with each other or may be spaced apart from each other as a gap or another structural element is interposed between them.

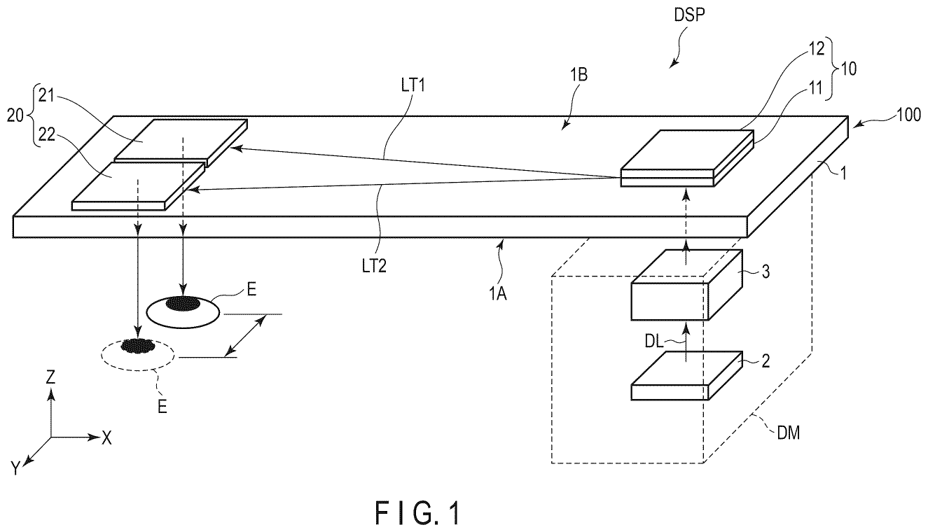

FIG. 1 is a view showing a configuration example of a display device DSP.

The display device DSP comprises a display module DM and a liquid crystal optical element 100. The liquid crystal optical element 100 comprises a transparent substrate 1, a first optical element 10, and a second optical element 20. The display module DM comprises a display element 2 and an optical system 3.

For example, the transparent substrate 1 is a glass substrate, but may also be a resin substrate. The transparent substrate 1 is formed into a flat plate shape and has a first main surface 1A and a second main surface 1B on a side opposite to the first main surface 1A. The first main surface 1A and the second main surface 1B are substantially parallel to the X-Y plane and face each other in the third direction Z. For example, each of the first main surface 1A and the second main surface 1B is formed in a rectangular shape having a pair of long sides extending in the first direction X and a pair of short sides extending in the second direction Y. The third direction Z corresponds to the thickness direction of the transparent substrate 1.

The display element 2 is provided on the side facing the first main surface 1A of the transparent substrate 1 in the third direction Z and is configured to emit a display light DL toward the transparent substrate 1. This display element 2 may be, for example, a display element which comprises a self-luminous element such as an organic electroluminescent element or a light emitting diode, or may be a display element in which an optical switch and an illumination device are combined with each other such as a liquid crystal panel.

The optical system 3 is provided between the display element 2 and the transparent substrate 1 in the third direction Z. This optical system 3 comprises at least one lens and is configured to collimate the divergent display light DL emitted from the display element 2.

The first optical element 10 faces the display element 2 via the transparent substrate 1 in the third direction Z and is provided on the second main surface 1B. That is, the transparent substrate 1 is located between the display element 2 and the first optical element 10 in the third direction Z. In one example, the first optical element 10 is bonded to the transparent substrate 1. This first optical element 10 is configured to reflect the display light DL having passed through the transparent substrate 1. The angle at which the display light DL is reflected in the first optical element 10 is set such that the display light DL undergoes total internal reflection within the transparent substrate 1.

The second optical element 20 is spaced apart from the first optical element 10, faces an eye E of a user in the third direction Z, and is provided on the second main surface 1B. The first optical element 10 and the second optical element 20 are arranged at a distance from each other in the first direction X. In one example, the second optical element 20 is bonded to the transparent substrate 1. This second optical element 20 is configured to reflect the display light DL having propagated inside the transparent substrate 1. The angle at which the display light DL is reflected in the second optical element 20 is set such that the display light DL is emitted from the first main surface 1A at an angle substantially perpendicular to the first main surface 1A. The reflection in the first optical element 10 and the second optical element 20 involves diffraction in each of the first optical element 10 and the second optical element 20.

For example, each of the first optical element 10 and the second optical element 20 may be formed of a liquid crystal layer containing cholesteric liquid crystal. Alternatively, each of the first optical element 10 and the second optical element 20 may be a diffractive element such as a holographic optical element (HOE) that diffracts incident light at a predetermined diffraction angle.

The first optical element 10 comprises liquid crystal layers 11 and 12. The liquid crystal layer 11 is provided on the second main surface 1B. The liquid crystal layer 12 overlaps the liquid crystal layer 11. That is, the first optical element 10 is configured as a stacked layer body of a plurality of liquid crystal layers.

The second optical element 20 comprises liquid crystal layers 21 and 22. The liquid crystal layers 21 and 22 are provided on the second main surface 1B and are arranged in the second direction Y. The liquid crystal layers 11, 12, 21, and 22 contain cholesteric liquid crystals. This configuration will be described in detail later.

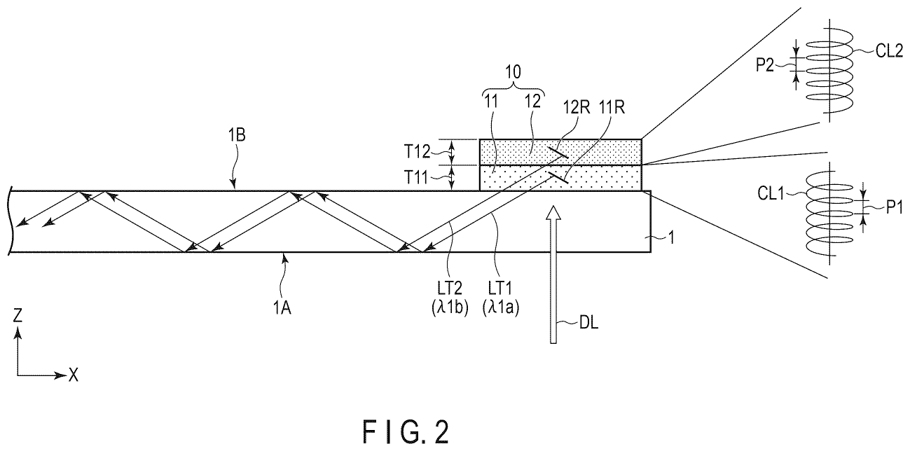

FIG. 2 is a view for describing the first optical element 10 of the display device DSP shown in FIG. 1.

The liquid crystal layer 11 contains a cholesteric liquid crystal CL1 as schematically shown in the enlarged view. The cholesteric liquid crystal CL1 has a helical pitch P1 along the third direction Z. The helical pitch indicates one period of the helix (in other words, the layer thickness along the third direction Z required for a 360-degree rotation of the liquid crystal molecule).

As shown schematically and enlarged, the liquid crystal layer 12 contains a cholesteric liquid crystal CL2 twisted in the opposite direction to the cholesteric liquid crystal CL1. The cholesteric liquid crystal CL2 has a helical pitch P2 along the third direction Z. The helical pitches P1 and P2 are equivalent to each other.

Each of the liquid crystal layers 11 and 12 is configured to reflect, of incident light, circularly polarized light in a selective reflection band determined based on the helical pitch P and the refractive anisotropy Δn of the liquid crystal film.

The liquid crystal layer 11 has a reflective surface 11R reflecting circularly polarized light corresponding to the rotational direction of the cholesteric liquid crystal CL1 in the selective reflection band. The liquid crystal layer 12 has a reflective surface 12R reflecting circularly polarized light corresponding to the rotational direction of the cholesteric liquid crystal CL2 in the selective reflection band. Each of the reflective surfaces 11R and 12R inclines with respect to the X-Y plane. In this specification, circularly polarized light may be strict circularly polarized light or may be circularly polarized light which approximates elliptically polarized light.

As an example, the following will describe a case where the display light DL with a random polarization state enters the liquid crystal layers 11 and 12. The liquid crystal layer 11 reflects light LT1, which is a part of the display light DL, at the reflective surface 11R. The liquid crystal layer 12 reflects light LT2, which is another part of the display light DL, at the reflective surface 12R. As described above, the helical pitches P1 and P2 are equivalent to each other. Thus, the light LT1 and the light LT2 are light in the same wavelength band λ1. Furthermore, the rotational directions of the cholesteric liquid crystals CL1 and CL2 differ from each other. Thus, the light LT1 and the light LT2 are circularly polarized in opposite directions. For example, the light LT1 is right-handed circularly polarized light λ1a, and the light LT2 is left-handed circularly polarized light λ1b.

Each of the light LT1 and the light LT2 propagates in the transparent substrate 1 while undergoing total internal reflection at the first main surface 1A and the second main surface 1B. As shown in FIG. 1, each of the light LT1 and the light LT2 propagates in directions different from the first direction X and the second direction Y. More specifically, the light LT1 reflected by the liquid crystal layer 11 propagates toward the liquid crystal layer 21 of the second optical element 20. The light LT2 reflected by the liquid crystal layer 12 propagates toward the liquid crystal layer 22 of the second optical element 20.

In the third direction Z, the liquid crystal layer 11 has a thickness T11, and the liquid crystal layer 12 has a thickness T12. For example, the diffraction efficiency is defined as the ratio of the intensity of the reflected light (the first diffraction light) in the liquid crystal layer to the intensity of the incident light. In this case, each of the thickness T11 and the thickness T12 is preferably several times to about ten times the helical pitch in order to improve the diffraction efficiency in the liquid crystal layers 11 and 12. In one example, the thickness T11 and the thickness T12 are equivalent to each other and are approximately 3 μm. Furthermore, the diffraction efficiency of the liquid crystal layer 12 is equivalent to that of the liquid crystal layer 11.

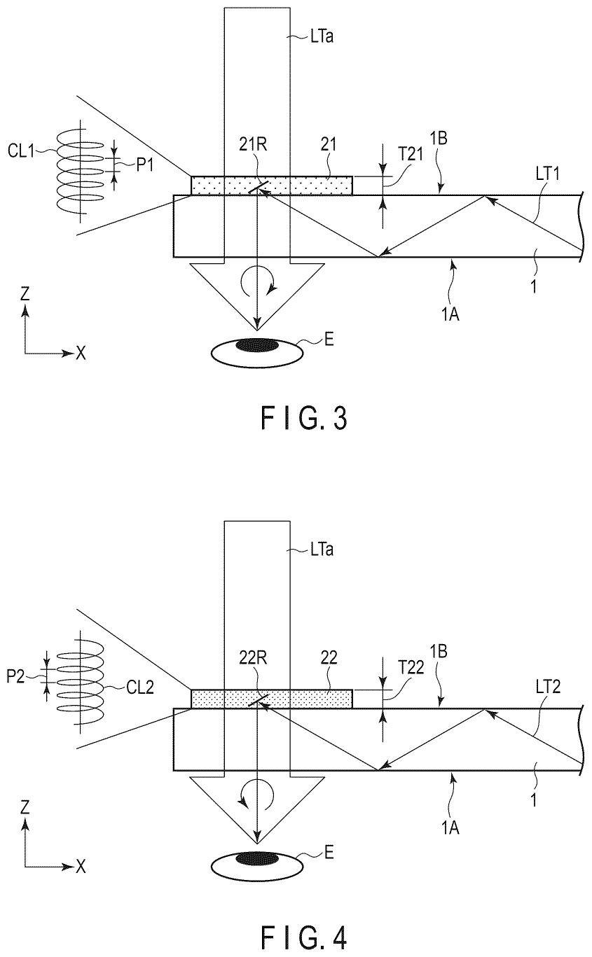

FIG. 3 is a view for describing the liquid crystal layer 21 of the second optical element 20 of the display device DSP shown in FIG. 1.

The liquid crystal layer 21 contains the cholesteric liquid crystal CL1 as schematically shown in the enlarged view. The cholesteric liquid crystal CL1 has the helical pitch P1 along the third direction Z. That is, the liquid crystal layer 21 has the same configuration as the liquid crystal layer 11. The liquid crystal layer 21 has a reflective surface 21R reflecting circularly polarized light corresponding to the rotational direction of the cholesteric liquid crystal CL1 (for example, right-handed circularly polarized light) in the selective reflection band. The reflective surface 21R inclines with respect to the X-Y plane. The liquid crystal layer 21 is configured to reflect the light LT1 along the normal to the second main surface 1B.

When the eye E of a user faces the liquid crystal layer 21 in the third direction Z, the user can visually recognize the light LT1 reflected at the liquid crystal layer 21. The user can visually recognize external light LTa via the liquid crystal layer 21 as well.

The liquid crystal layer 21 has a thickness T21 in the third direction Z. When the display device DSP is used for providing an augmented reality (AR), the liquid crystal layer 21 is required to have a sufficient transmittance. Thus, the diffraction efficiency of the liquid crystal layer 21 in the second optical element 20 is preferably lower than that of the liquid crystal layer 11 in the first optical element 10. That is, the liquid crystal layer 21 is preferably thinner than the liquid crystal layer 11. That is, the thickness T21 is preferably smaller than the thickness T11. In one example, the thickness T21 is approximately 1 μm to 2 μm.

FIG. 4 is a view for describing the liquid crystal layer 22 of the second optical element 20 of the display device DSP shown in FIG. 1.

The liquid crystal layer 22 contains the cholesteric liquid crystal CL2 as schematically shown in the enlarged view. The cholesteric liquid crystal CL2 has the helical pitch P2 along the third direction Z. That is, the liquid crystal layer 22 has the same configuration as the liquid crystal layer 12. The liquid crystal layer 22 has a reflective surface 22R reflecting circularly polarized light corresponding to the rotational direction of the cholesteric liquid crystal CL2 (for example, left-handed circularly polarized light) in the selective reflection band. The reflective surface 22R inclines with respect to the X-Y plane. The liquid crystal layer 22 is configured to reflect the light LT2 along the normal to the second main surface 1B.

When the eye E of a user faces the liquid crystal layer 22 in the third direction Z, the user can visually recognize the light LT2 reflected at the liquid crystal layer 22. The user can visually recognize the external light LTa via the liquid crystal layer 22 as well.

The liquid crystal layer 22 has a thickness T22 in the third direction Z. For the liquid crystal layer 22 to have a sufficient transmittance, the diffraction efficiency of the liquid crystal layer 22 in the second optical element 20 is preferably lower than that of the liquid crystal layer 12 in the first optical element 10. That is, the liquid crystal layer 22 is preferably thinner than the liquid crystal layer 12. That is, the thickness T22 is preferably smaller than the thickness T12. In one example, the thickness T22 is approximately 1 μm to 2 μm. Further, the diffraction efficiency of the liquid crystal layer 22 is equivalent to that of the liquid crystal layer 21. The thickness T22 is equivalent to the thickness T21.

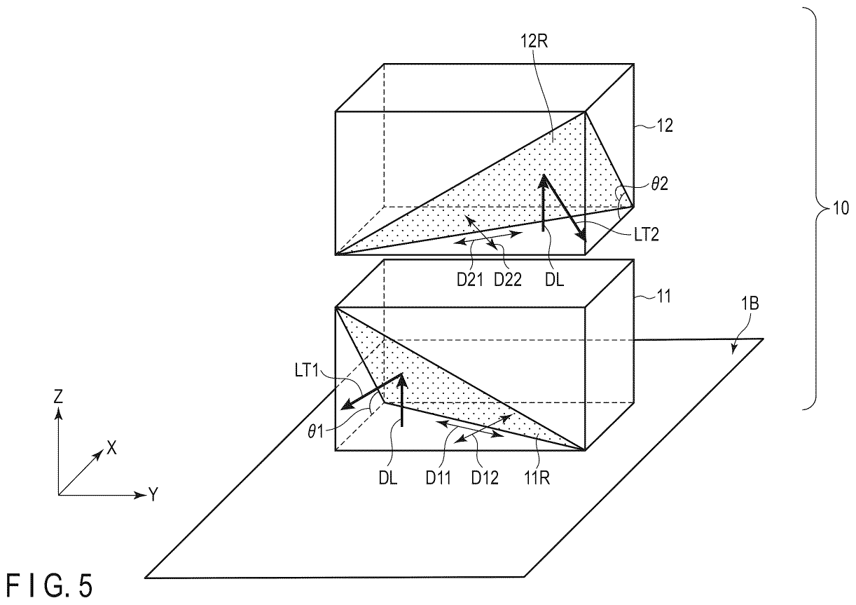

FIG. 5 is a view for describing the reflective surfaces 11R and 12R in the first optical element 10 shown in FIG. 1.

Each of the reflective surfaces 11R and 12R inclines with respect to the second main surface 1B parallel to the X-Y plane. Each of the reflective surfaces 11R and 12R inclines with respect to the X-Y plane and the Y-Z plane. Further, the reflective surfaces 11R and 12R are not parallel to each other.

The intersection line along which the reflection surface 11R intersects the X-Y plane is parallel to direction D11 and intersects the first direction X and the second direction Y. An angle θ1 between the reflective surface 11R and the X-Y plane in the X-Z plane is an acute angle. The display light DL traveling along the third direction Z is reflected along a direction D12 orthogonal to the direction D11 at the reflective surface 11R. That is, the traveling direction of the light LT1 reflected at the reflecting surface 11R differs from the first direction X and the second direction Y and is parallel to the direction D12 in the X-Y plane.

The intersection line along which the reflecting surface 12R intersects the X-Y plane is parallel to a direction D21, intersects the first direction X and the second direction Y, and also intersects the direction D11. An angle θ2 between the reflective surface 12R and the X-Y plane in the X-Z plane is an acute angle. For example, the angle θ2 is equivalent to the angle θ1. Alternatively, the angle θ2 may differ from the angle θ1. The display light DL traveling along the third direction Z is reflected along a direction D22 orthogonal to the direction D21 at the reflective surface 12R. That is, the traveling direction of the light LT2 reflected at the reflecting surface 12R differs from the first direction X and the second direction Y and is parallel to the direction D22 in the X-Y plane.

Next, the following will describe configurations of the liquid crystal layers 11 and 12.

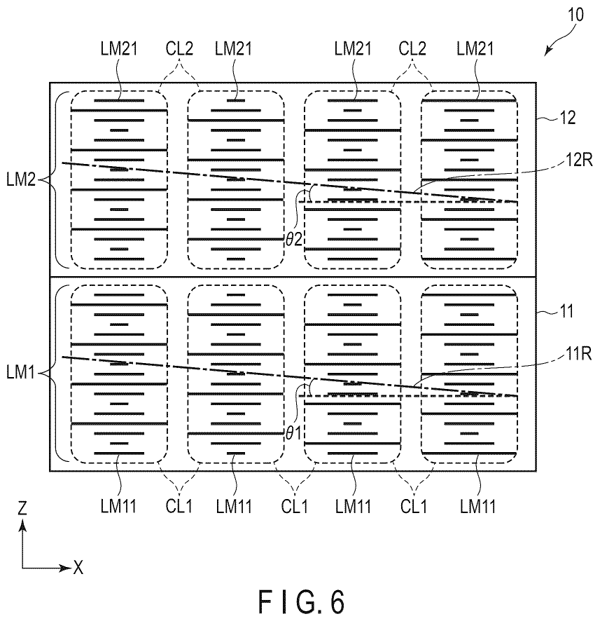

FIG. 6 is a cross-sectional view for describing an example of the cholesteric liquid crystal CL1 contained in the liquid crystal layer 11 and the cholesteric liquid crystal CL2 contained in the liquid crystal layer 12 shown in FIG. 5.

When one of the cholesteric liquid crystals CL1 surrounded by broken lines in the liquid crystal layer 11 is particularly looked at, the cholesteric liquid crystal CL1 consists of a plurality of liquid crystal molecules LM1 helically stacked along the third direction Z while twisting. To simplify the illustration, FIG. 6 shows one liquid crystal molecule LM1 among the liquid crystal molecules located in the same plane parallel to an X-Y plane as the liquid crystal molecules LM1 constituting each cholesteric liquid crystal CL1. The alignment direction of each liquid crystal molecule LM1 shown in the figure corresponds to the average alignment direction of the liquid crystal molecules located in the same plane.

In the illustrated X-Z cross section, the alignment directions of the cholesteric liquid crystals CL1 adjacent to each other along the first direction X differ from each other. In a plurality of cholesteric liquid crystals CL1 adjacent to each other along the first direction X, the alignment directions of the liquid crystal molecules LM11 located in the same plane differ from each other.

The reflective surface 11R indicated by one-dot chain line in the figure corresponds to a surface in which the alignment directions of the liquid crystal molecules LM1 are uniform, or a surface (an equiphase wave surface) in which the spatial phase is uniform.

When one of the cholesteric liquid crystals CL2 surrounded by broken lines in the liquid crystal layer 12 is particularly looked at, the cholesteric liquid crystal CL2 consists of a plurality of liquid crystal molecules LM2 helically stacked along the third direction Z while twisting. FIG. 6 shows the liquid crystal molecules LM2 constituting the cholesteric liquid crystal CL2 in the liquid crystal layer 12 in the same simplified manner as the liquid crystal layer 11.

In the illustrated X-Z cross section, the alignment directions of the cholesteric liquid crystals CL2 adjacent to each other along the first direction X differ from each other. In the plurality of cholesteric liquid crystals CL2 adjacent to each other along the first direction X, the alignment directions of the liquid crystal molecules LM21 located in the same plane differ from each other.

The reflective surface 12R indicated by one-dot chain line in the figure corresponds to a surface in which the alignment directions of the liquid crystal molecules LM2 are uniform, or a surface (an equiphase wave surface) in which the spatial phase is uniform.

These liquid crystal layers 11 and 12 are cured in a state where the alignment directions of the liquid crystal molecules are fixed. That is, unlike those of general liquid crystal elements, the alignment directions of the liquid crystal molecules are not controlled by an electric field.

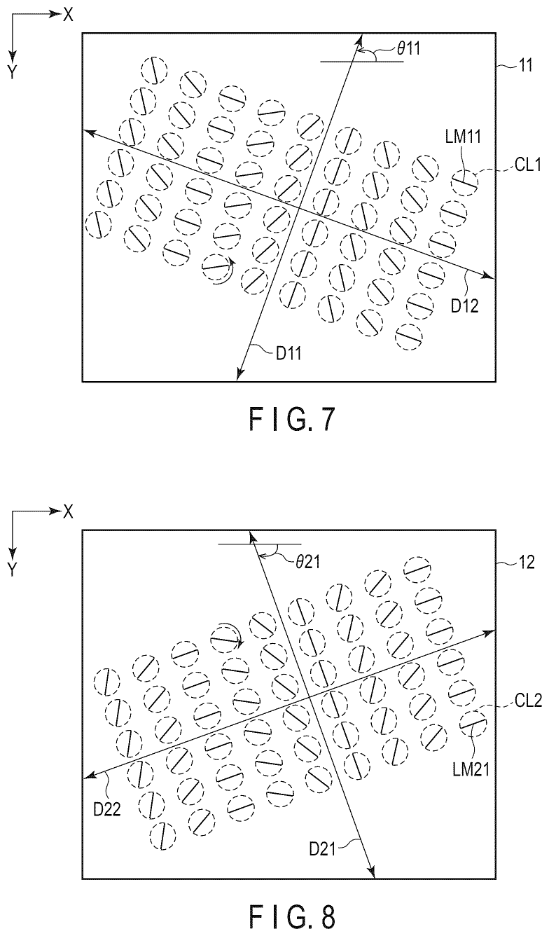

FIG. 7 is a plan view schematically showing the liquid crystal layer 11 shown in FIG. 5.

FIG. 7 shows an example of the spatial phases of the cholesteric liquid crystals CL1. Here, the spatial phases are shown as the alignment directions of the liquid crystal molecules LM11 contained in the cholesteric liquid crystals CL1 indicated by the dashed circle. In the X-Y plane, the directions D11 and D12 are orthogonal to each other. The direction D11 intersects the first direction X at an angle θ11. The angle θ11 is an acute angle counterclockwise with respect to the first direction X.

In contrast, in the cholesteric liquid crystals CL1 arranged along the direction D11, the alignment directions of the liquid crystal molecules LM11 are substantially equivalent to each other. That is, the spatial phases of the cholesteric liquid crystals CL1 are substantially equivalent to each other in the direction D11.

In the cholesteric liquid crystals CL1 arranged along the direction D12, the alignment directions of the liquid crystal molecules LM11 differ from each other. That is, the spatial phases of the cholesteric liquid crystals CL1 differ along the direction D12.

In particular, regarding the cholesteric liquid crystals CL1 arranged along the direction D12, the alignment direction varies with each liquid crystal molecule LM11 by a certain degree. That is, the alignment direction linearly varies with the liquid crystal molecules LM11 arranged along the direction D12. Thus, as shown in FIG. 5 and FIG. 6, the reflective surface 11R inclined with respect to the X-Y plane is formed. Here, the phrase “linearly vary” means that, for example, the amount of variation in the alignment directions of the liquid crystal molecules LM11 is shown by a linear function. Here, the alignment direction of each liquid crystal molecule LM11 corresponds to the long axis direction of the liquid crystal molecule LM11 in the X-Y plane.

FIG. 8 is a plan view schematically showing the liquid crystal layer 12 shown in FIG. 5.

FIG. 8 shows an example of the spatial phases of the cholesteric liquid crystals CL2. Here, the spatial phases are shown as the alignment directions of the liquid crystal molecules LM21 contained in the cholesteric liquid crystals CL2 indicated by the dashed circle. In the X-Y plane, the directions D21 and D22 are orthogonal to each other. The direction D21 intersects the first direction X at an angle θ21. The angle θ21 is an acute angle clockwise with respect to the first direction X. For example, the angle θ21 is equivalent to the angle θ11. Alternatively, the angle θ21 may differ from the angle θ11.

In contrast, in the cholesteric liquid crystals CL2 arranged along the direction D21, the alignment directions of the liquid crystal molecules LM21 are substantially equivalent to each other. That is, the spatial phases of the cholesteric liquid crystals CL2 are substantially equivalent to each other in the direction D21.

In the cholesteric liquid crystals CL2 arranged along the direction D22, the alignment directions of the liquid crystal molecules LM21 differ from each other. That is, the spatial phases of the cholesteric liquid crystals CL2 differ along the direction D22.

In particular, regarding the cholesteric liquid crystals CL2 arranged along the direction D22, the alignment direction varies with each liquid crystal molecule LM21 by a certain degree. That is, the alignment direction linearly varies with the liquid crystal molecules LM21 arranged along the direction D22. Thus, as shown in FIG. 5 and FIG. 6, the reflective surface 12R inclined with respect to the X-Y plane is formed.

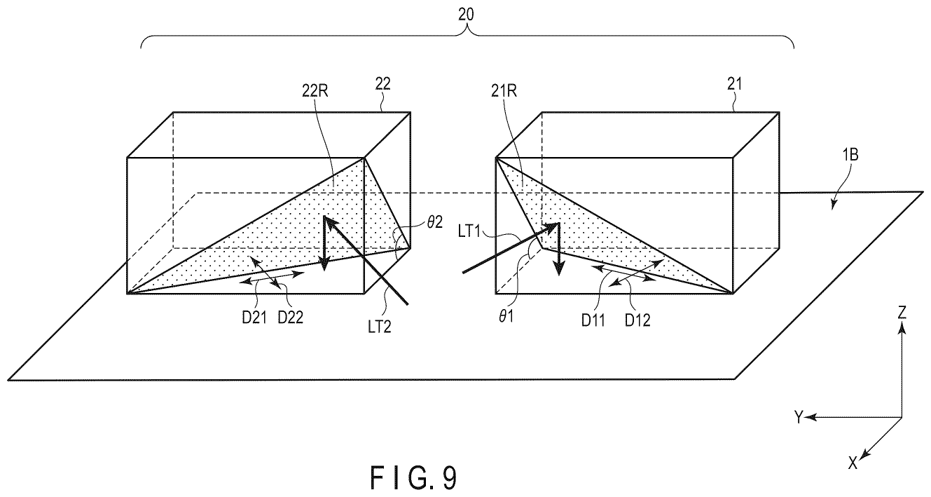

FIG. 9 is a view for describing the reflective surfaces 21R and 22R in the second optical element 20 shown in FIG. 1.

Each of the reflective surfaces 21R and 22R inclines with respect to the second main surface 1B parallel to the X-Y plane. Each of the reflective surfaces 21R and 22R inclines with respect to the X-Y plane and the Y-Z plane. Further, the reflective surfaces 21R and 22R are not parallel to each other.

The reflective surface 21R is not parallel to the reflective surface 11R shown in FIG. 5. The intersection line along which the reflective surface 21R and the X-Y plane intersect each other is parallel to the direction D11. The light LT1 traveling along the direction D12 is reflected along the third direction Z at the reflective surface 21R. The reflective surface 21R is formed in the same manner as the reflective surface 11R of the liquid crystal layer 11 described with reference to FIG. 6 and the like.

The reflective surface 22R is not parallel to the reflective surface 12R shown in FIG. 5. The intersection line along which the reflective surface 22R and the X-Y plane intersect each other is parallel to the direction D21. The light LT2 traveling along the direction D22 is reflected along the third direction Z at the reflective surface 22R. The reflective surface 22R is formed in the same manner as the reflective surface 12R of the liquid crystal layer 12 described with reference to FIG. 6 and the like.

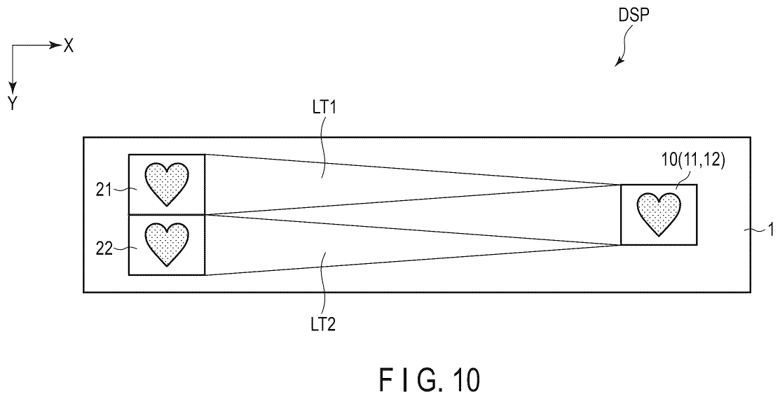

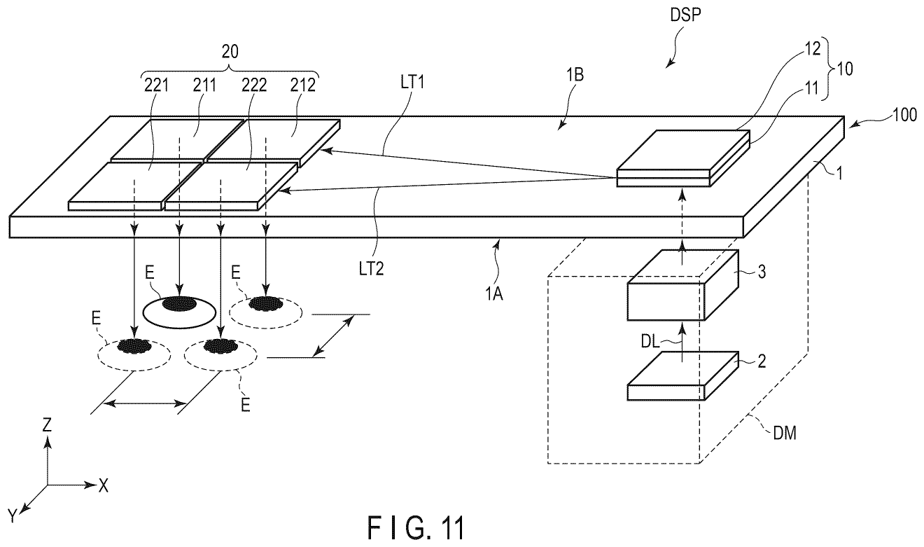

FIG. 10 is a plan view showing an example of an image displayed in the display device DSP shown in FIG. 1.

For example, when a heart-shaped image is displayed in the display element 2 shown in FIG. 1, the display light DL emitted from the display element 2 is reflected in the liquid crystal layer 11 of the first optical element 10 toward the liquid crystal layer 21 of the second optical element 20, and is reflected in the liquid crystal layer 12 toward the liquid crystal layer 22 of the second optical element 20. Each of the light LT1 reflected at the liquid crystal layer 11 and the light LT2 reflected at the liquid crystal layer 12 propagates through the transparent substrate 1. Then, the light LT1 is reflected at the liquid crystal layer 21, and the light LT2 is reflected in the liquid crystal layer 22 toward the position different from that of the light LT1. Thus, two heart-shaped images aligned in the second direction Y are displayed.

As shown in FIG. 1, when the eye E faces the liquid crystal layer 21 as indicated by the solid line, the user can visually recognize the heart-shaped image as the light LT1. Furthermore, when the eye E faces the liquid crystal layer 22 as indicated by the dashed line, the user can visually recognize the heart-shaped image as the light LT2.

In the display device DSP, an image displayed in the display element 2 is divided into two parts. These two parts are displayed and aligned in the second direction Y. Thus, even when a plurality of users with different positions of eyes E use the display device DSP, each user can visually recognize the display light DL at the optimal location corresponding to their positions of the eyes E. In this manner, the reduction in the visibility of images can be prevented without giving each user uncomfortable feeling.

Further, in the first optical element 10, the diffraction efficiency of the liquid crystal layer 11 is equivalent to that of the liquid crystal layer 12. Thus, the intensity of the light LT1 reflected in the liquid crystal layer 11 is equivalent to the intensity of the light LT2 reflected in the liquid crystal layer 12. Further, in the second optical element 20, the diffraction efficiency of the liquid crystal layer 21 is equivalent to that of the liquid crystal layer 22. Thus, the intensity of the light LT1 reflected in the liquid crystal layer 21 is equivalent to the intensity of the light LT2 reflected in the liquid crystal layer 22. Thus, regardless of whether the user visually recognizes the light LT1 or the light LT2, the user can visually recognize an image of the same brightness.

Further, in the second optical element 20, each of the liquid crystal layers 21 and 22 is thinner than the liquid crystal layers 11 and 12. Thus, a user can visually recognize external light through the second optical element 20.

In this configuration example, the liquid crystal layer 11 corresponds to the first liquid crystal layer of the first optical element 10. The liquid crystal layer 12 corresponds to the second liquid crystal layer of the first optical element 10. The liquid crystal layer 21 corresponds to the first liquid crystal layer of the second optical element 20. The liquid crystal layer 22 corresponds to the second liquid crystal layer of the second optical element 20. Furthermore, the cholesteric liquid crystal CL1 corresponds to the first cholesteric liquid crystal. The cholesteric liquid crystal CL2 corresponds to the second cholesteric liquid crystal. The helical pitches P1 and P2 correspond to the first helical pitches. The reflective surface 11R corresponds to the first reflective surface of the first optical element 10. The reflective surface 12R corresponds to the second reflective surface of the first optical element 10. The reflective surface 21R corresponds to the first reflective surface of the second optical element 20. The reflective surface 22R corresponds to the second reflective surface of the second optical element 20.

Here, the following will briefly describe an example of a manufacturing method for the liquid crystal layer applied to each of the first optical element 10 and the second optical element 20.

First, an alignment film is formed on a separate support substrate different from the transparent substrate 1. The alignment film has an alignment axis of a prescribed alignment pattern. For example, this prescribed alignment pattern is formed by applying an interference exposure method using right-handed circularly polarized light and left-handed circularly polarized light. Then, a solution containing a polymerizable liquid crystal material and a polymerization initiator are applied onto the alignment film. The solvent of the coated solution is removed by vacuum drying. Then, the polymerizable liquid crystal material is heated to a temperature not exceeding the NI point (nematic-isotropic transition temperature) and subsequently cooled. In this process, the liquid crystal molecules contained in the polymerizable liquid crystal materials are arranged in a helical shape by an alignment restriction force of the alignment film. Then, the polymerizable liquid crystal material and polymerization initiator are irradiated with ultraviolet light. Thus, the liquid crystal molecules are cured into a polymeric liquid crystal materials while exhibiting a cholesteric liquid crystal phase. Thus, the liquid crystal layer is formed. The liquid crystal layer formed in this manner is stripped from the alignment film and then is transferred onto the transparent substrate 1.

In the first optical element 10 and the second optical element 20, light can be reflected in a desired direction by adjusting the alignment pattern formed on the alignment film, adjusting the angle of the support substrate, or tilting the liquid crystal layer transferred onto the transparent substrate 1 within the X-Y plane.

Next, the following will describe several other configurations. The same constituent elements as in the above configuration example are denoted by the same reference numerals and their overlapping explanations are omitted in some cases.

FIG. 11 is a view showing another configuration example of the display device DSP.

The configuration example shown in FIG. 11 differs from the configuration example shown in FIG. 1 in that the second optical element 20 comprises four liquid crystal layers. In the same manner as in the configuration example shown in FIG. 1, the first optical element 10 is formed as a stacked layer body of the liquid crystal layers 11 and 12.

The second optical element 20 comprises liquid crystal layers 211, 212, 221, and 222. The liquid crystal layers 211 and 221 are arranged in the second direction Y. The liquid crystal layers 211 and 212 are arranged in the first direction X. The liquid crystal layers 221 and 222 are arranged in the first direction X. The liquid crystal layers 212 and 222 are arranged in the second direction Y.

The liquid crystal layer 212 is located between the liquid crystal layer 211 and the first optical element 10 and is close to the liquid crystal layer 211. The liquid crystal layer 222 is located between the liquid crystal layer 221 and the first optical element 10 and is close to the liquid crystal layer 221.

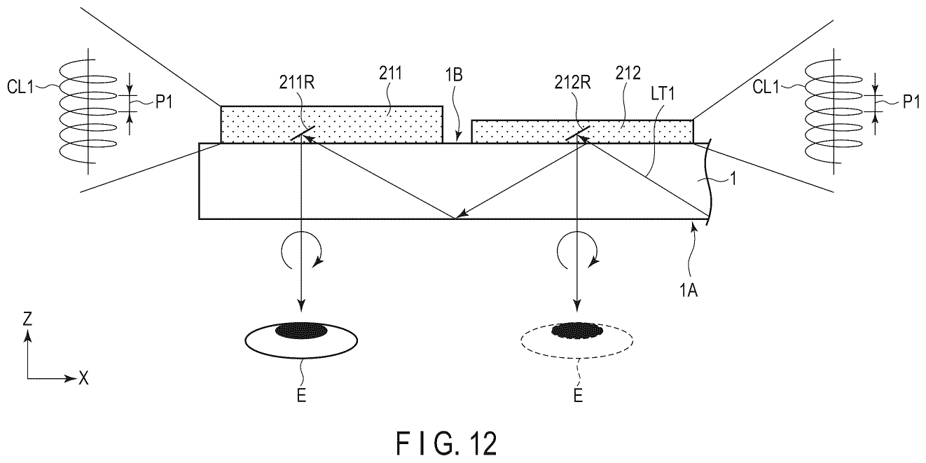

FIG. 12 is a view for describing the liquid crystal layers 211 and 212 of the display device DSP shown in FIG. 11.

The liquid crystal layers 211 and 212 contain the same cholesteric liquid crystals CL1 as schematically shown in the enlarged view. The cholesteric liquid crystal CL1 has the helical pitch P1 along the third direction Z. The liquid crystal layer 211 has a reflective surface 211R. The liquid crystal layer 212 has a reflective surface 212R. The reflective surfaces 211R and 212R reflect circularly polarized light corresponding to the rotational direction of the cholesteric liquid crystal CL1 (for example, right-handed circularly polarized light) in the selective reflection band.

The reflective surfaces 211R and 212R incline with respect to the X-Y plane. The liquid crystal layer 211 is configured to reflect a part of the light LT1 along the normal to the second main surface 1B. Further, the liquid crystal layer 212 is configured to reflect another part of the light LT1 along the normal to the second main surface 1B.

When the eye E of a user faces the liquid crystal layer 211 in the third direction Z, the user can visually recognize the light LT1. When the eye E of a user faces the liquid crystal layer 212 in the third direction Z as well, the user can visually recognize the light LT1.

As described above, the liquid crystal layer 212 is closer to the first optical element 10 than the liquid crystal layer 211 is. Thus, the light LT1 that reaches the liquid crystal layer 211 is more attenuated than the light LT1 that reaches the liquid crystal layer 212. To suppress attenuations of the light LT1, the diffraction efficiency of the liquid crystal layer 212 is preferably lower than that of the liquid crystal layer 211. Whether the eye E faces the liquid crystal layers 211 or 212, the diffraction efficiency of the liquid crystal layer 211 is preferably higher than that of the liquid crystal layer 212 in order to equalize the strength of the light LT1 that is visually recognized. Thus, the liquid crystal layer 211 is thicker than the liquid crystal layer 212 in the illustrated example.

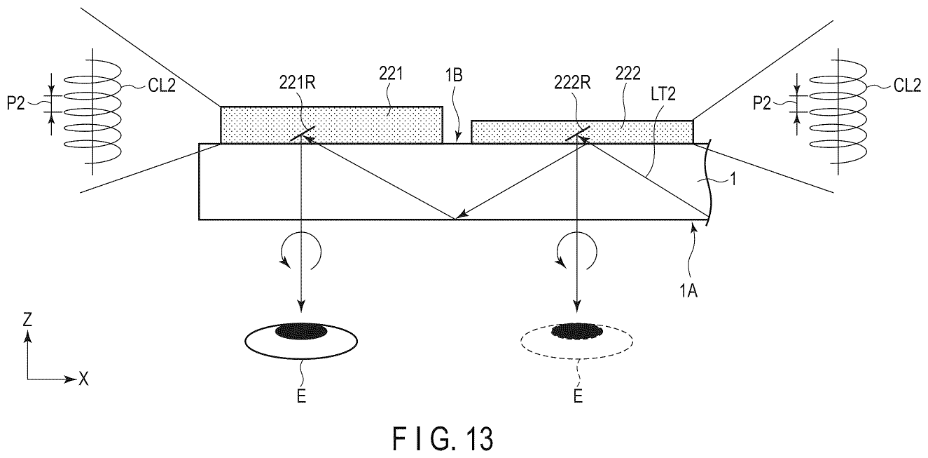

FIG. 13 is a view for describing the liquid crystal layers 221 and 222 of the display device DSP shown in FIG. 11.

The liquid crystal layers 221 and 222 contain the same cholesteric liquid crystals CL2 as schematically shown in the enlarged view. The cholesteric liquid crystal CL2 has the helical pitch P2 along the third direction Z. The liquid crystal layer 221 has a reflective surface 221R. The liquid crystal layer 222 has a reflective surface 222R. The reflective surfaces 221R and 222R reflect circularly polarized light corresponding to the rotational direction of the cholesteric liquid crystal CL2 (for example, left-handed circularly polarized light) in the selective reflection band.

The reflective surfaces 221R and 222R incline with respect to the X-Y plane. The liquid crystal layer 221 is configured to reflect a part of the light LT2 along the normal to the second main surface 1B. Further, the liquid crystal layer 222 is configured to reflect another part of the light LT2 along the normal to the second main surface 1B.

When the eye E of a user faces the liquid crystal layer 221 in the third direction Z, the user can visually recognize the light LT2. When the eye E of a user faces the liquid crystal layer 222 in the third direction Z as well, the user can visually recognize the light LT2.

As described above, the liquid crystal layer 222 is closer to the first optical element 10 than the liquid crystal layer 221 is. Thus, the light LT2 that reaches the liquid crystal layer 221 is more attenuated than the light LT2 that reaches the liquid crystal layer 222. To suppress attenuations of the light LT2, the diffraction efficiency of the liquid crystal layer 222 is preferably lower than that of the liquid crystal layer 221. Whether the eye E faces the liquid crystal layers 221 or 221, the diffraction efficiency of the liquid crystal layer 221 is preferably higher than that of the liquid crystal layer 222 in order to equalize the strength of the light LT2 that is visually recognized. Thus, the liquid crystal layer 221 is thicker than the liquid crystal layer 222 in the illustrated example.

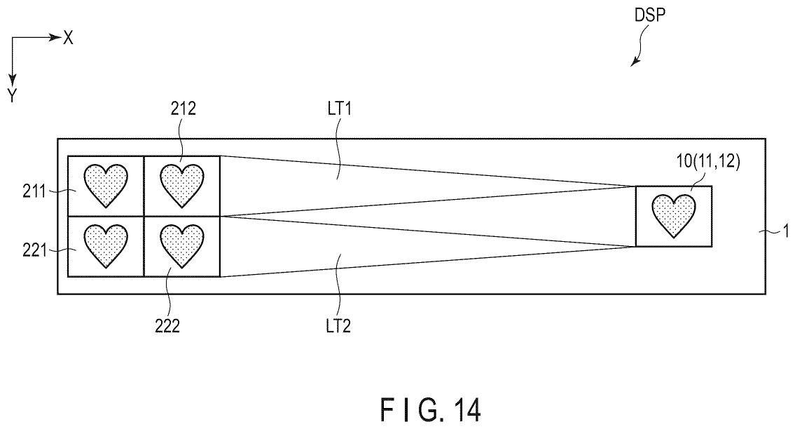

FIG. 14 is a plan view showing an example of an image displayed in the display device DSP shown in FIG. 11.

For example, when a heart-shaped image is displayed in the display element 2 shown in FIG. 11, the display light DL emitted from the display element 2 is reflected in the liquid crystal layer 11 of the first optical element 10 toward the liquid crystal layers 211 and 212 of the second optical element 20, and is reflected in the liquid crystal layer 12 toward the liquid crystal layers 221 and 222 of the second optical element 20. Each of the light LT1 reflected at the liquid crystal layer 11 and the light LT2 reflected at the liquid crystal layer 12 propagates through the transparent substrate 1. Then, the light LT1 is reflected at the liquid crystal layers 211 and 212, and the light LT2 is reflected in the liquid crystal layers 221 and 222 toward the position different from that of the light LT1. Thus, four heart-shaped images aligned in the first direction X and the second direction Y are displayed.

As shown in FIG. 11, when the eye E faces the liquid crystal layer 211 as indicated by the solid line or the liquid crystal layer 212 as indicated by the solid line, the user can visually recognize the heart-shaped image as the light LT1. Further, when the eye E faces the liquid crystal layer 221 or the liquid crystal layer 222, the user can visually recognize the heart-shaped image as the light LT2.

In the display device DSP, an image displayed in the display element 2 is divided into four parts. These four parts are displayed and aligned in the first direction X and the second direction Y. Thus, even when a plurality of users with different positions of eyes E use the display device DSP, each user can visually recognize the display light DL at the optimal location corresponding to their positions of the eyes E. In this manner, the reduction in the visibility of images can be prevented without giving each user uncomfortable feeling.

Furthermore, in the second optical element 20, the diffraction efficiency of each of the liquid crystal layers 211, 212, 221, and 222 can be independently adjusted. Thus, as described with reference to FIG. 12, an image of the same brightness can be visually recognized regardless of whether the light LT1 reflected by the liquid crystal layer 211 or the light LT1 reflected by the liquid crystal layer 212 is visually recognized. Further, as described with reference to FIG. 13, an image of the same brightness can be visually recognized regardless of whether the light LT2 reflected by the liquid crystal layer 221 or the light LT2 reflected by the liquid crystal layer 222 is visually recognized.

Further, in the second optical element 20, the transmittances of the liquid crystal layers 211, 212, 221, and 222 can be equalized as well.

In this configuration example, the liquid crystal layer 211 corresponds to the first liquid crystal layer of the second optical element 20. The liquid crystal layer 221 corresponds to the second liquid crystal layer of the second optical element 20. The liquid crystal layer 212 corresponds to the third liquid crystal layer of the second optical element 20. The liquid crystal layer 222 corresponds to the fourth liquid crystal layer of the second optical element 20. Further, the cholesteric liquid crystal CL1 of the liquid crystal layer 211 corresponds to the first cholesteric liquid. The cholesteric liquid crystal CL2 of the liquid crystal layer 221 corresponds to the second cholesteric liquid crystal. The cholesteric liquid crystals CL1 of the liquid crystal layer 212 corresponds to the third cholesteric liquid crystal. The cholesteric liquid crystal CL2 of the liquid crystal layer 222 corresponds to the fourth cholesteric liquid crystal.

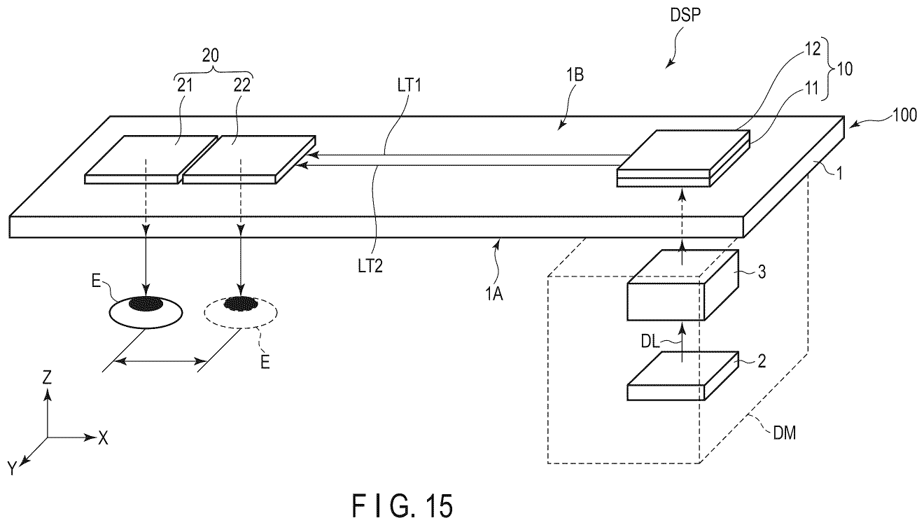

FIG. 15 is a view showing another configuration example of the display device DSP.

The configuration example shown in FIG. 15 differs from the configuration example shown in FIG. 1 in that the liquid crystal layers 21 and 22 are arranged in the first direction X in the second optical element 20. In the same manner as in the configuration example shown in FIG. 1, the first optical element 10 is formed as a stacked layer body of the liquid crystal layers 11 and 12.

The liquid crystal layer 22 is located between the liquid crystal layer 21 and the first optical element 10 and is close to the liquid crystal layer 21. As described with reference to FIG. 3, the liquid crystal layer 21 contains the cholesteric liquid crystal CL1. Further, as described with reference to FIG. 4, the liquid crystal layer 22 contains the cholesteric liquid crystal CL2. The diffraction efficiency of the liquid crystal layer 21 is equivalent to that of the liquid crystal layer 22. That is, the thickness of the liquid crystal layer 21 is equivalent to that of the liquid crystal layer 22.

However, in the first optical element 10, the reflective surface 11R of the liquid crystal layer 11 and the reflective surface 12R of the liquid crystal layer 12 have shapes different from those shown in FIG. 5. Further, in the second optical element 20, the reflective surface 21R of the liquid crystal layer 21 and the reflective surface 22R of the liquid crystal layer 22 have shapes different from those shown in FIG. 9. The following will describe a reflective surface of each of the first optical element 10 and the second optical element 20.

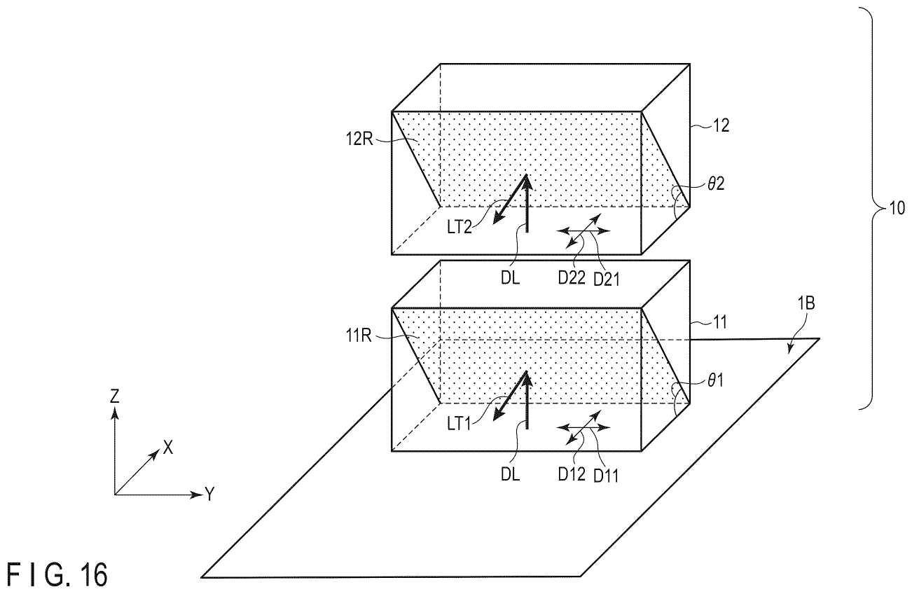

FIG. 16 is a view for describing the reflective surfaces 11R and 12R in the first optical element 10 shown in FIG. 15.

Each of the reflective surfaces 11R and 12R inclines with respect to the second main surface 1B parallel to the X-Y plane. Each of the reflective surfaces 11R and 12R inclines with respect to the X-Y plane and the Y-Z plane. Further, the reflective surfaces 11R and 12R are parallel to each other.

The intersection line along which the reflection surface 11R intersects the X-Y plane is parallel to the direction D11 and the second direction Y. The direction D12 orthogonal to the direction D11 is parallel to the first direction X. The display light DL traveling along the third direction Z is reflected along the direction D12 at the reflective surface 11R. That is, the traveling direction of the light LT1 reflected at the reflecting surface 11R is parallel to the first direction X or the direction D12 on the X-Y plane.

The intersection line along which the reflection surface 12R intersects the X-Y plane is parallel to the direction D21 and the second direction Y. Further, the direction D21 is parallel to the direction D11. The direction D22 orthogonal to the direction D21 is parallel to the first direction X and the direction D12. The display light DL traveling along the third direction Z is reflected along the direction D22 at the reflective surface 12R. That is, the traveling direction of the light LT2 reflected at the reflecting surface 12R is parallel to the first direction X or the direction D22 on the X-Y plane.

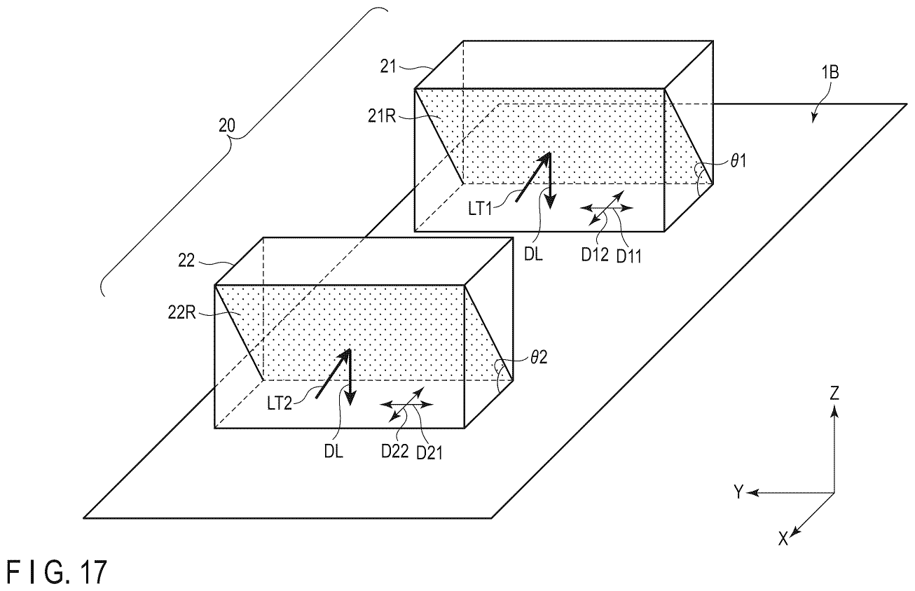

FIG. 17 is a view for describing the reflective surfaces 21R and 22R in the second optical element 20 shown in FIG. 15.

Each of the reflective surfaces 21R and 22R inclines with respect to the second main surface 1B parallel to the X-Y plane. Each of the reflective surfaces 21R and 22R inclines with respect to the X-Y plane and the Y-Z plane. Further, the reflective surfaces 21R and 22R are parallel to each other.

The reflective surface 21R is not parallel to the reflective surface 11R shown in FIG. 16. The intersection line along which the reflective surface 21R and the X-Y plane intersect each other is parallel to the direction D11. The light LT1 traveling along the direction D12 is reflected along the third direction Z at the reflective surface 21R.

The reflective surface 22R is not parallel to the reflective surface 12R shown in FIG. 16. The intersection line along which the reflective surface 22R and the X-Y plane intersect each other is parallel to the direction D21. The light LT2 traveling along the direction D22 is reflected along the third direction Z at the reflective surface 22R.

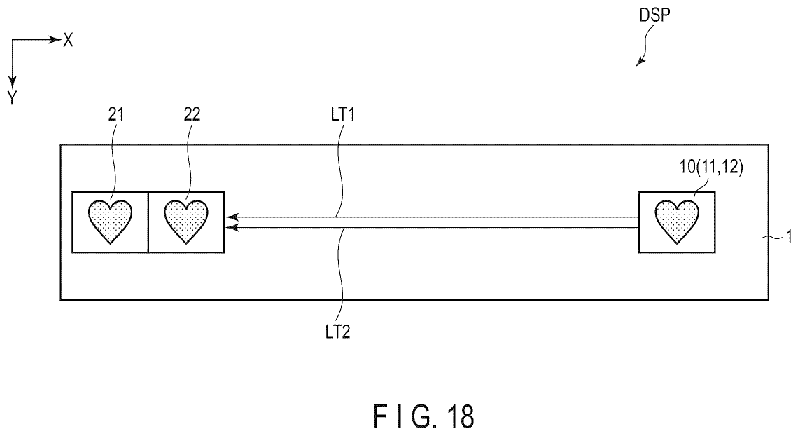

FIG. 18 is a plan view showing an example of an image displayed in the display device DSP shown in FIG. 15.

For example, when a heart-shaped image is displayed in the display element 2 shown in FIG. 15, the display light DL emitted from the display element 2 is reflected in the liquid crystal layer 11 of the first optical element 10 toward the liquid crystal layer 21 of the second optical element 20, and is reflected in the liquid crystal layer 12 toward the liquid crystal layer 22 of the second optical element 20. Each of the light LT1 reflected at the liquid crystal layer 11 and the light LT2 reflected at the liquid crystal layer 12 propagates through the transparent substrate 1 along the first direction X. Thus, the light LT1 is reflected at the liquid crystal layer 21. Further, the light LT2 is reflected in the liquid crystal layer 22 toward the position different from that of the light LT1. Thus, two heart-shaped images aligned in the second direction Y are displayed. The polarimetric direction of the light LT1 differs from that of the cholesteric liquid crystal CL2 constituting the liquid crystal layer 22. Thus, the light LT1 is not reflected at the liquid crystal layer 22.

As shown in FIG. 15, when the eye E faces the liquid crystal layer 21 as indicated by the solid line, the user can visually recognize the heart-shaped image as the light LT1. Furthermore, when the eye E faces the liquid crystal layer 22 as indicated by the dashed line, the user can visually recognize the heart-shaped image as the light LT2.

In the display device DSP, an image displayed in the display element 2 is divided into two parts. These two parts are displayed and aligned in the first direction X. Thus, even when a plurality of users with different positions of eyes E use the display device DSP, each user can visually recognize the display light DL at the optimal location corresponding to their positions of the eyes E. In this manner, the reduction in the visibility of images can be prevented without giving each user uncomfortable feeling.

The diffraction efficiencies of the liquid crystal layers 21 and 22 can be independently adjusted. Thus, regardless of whether the user visually recognizes the light LT1 or the light LT2, the user can visually recognize an image of the same brightness.

Further, in the second optical element 20, the transmittances of the liquid crystal layers 21 and 22 can be equalized.

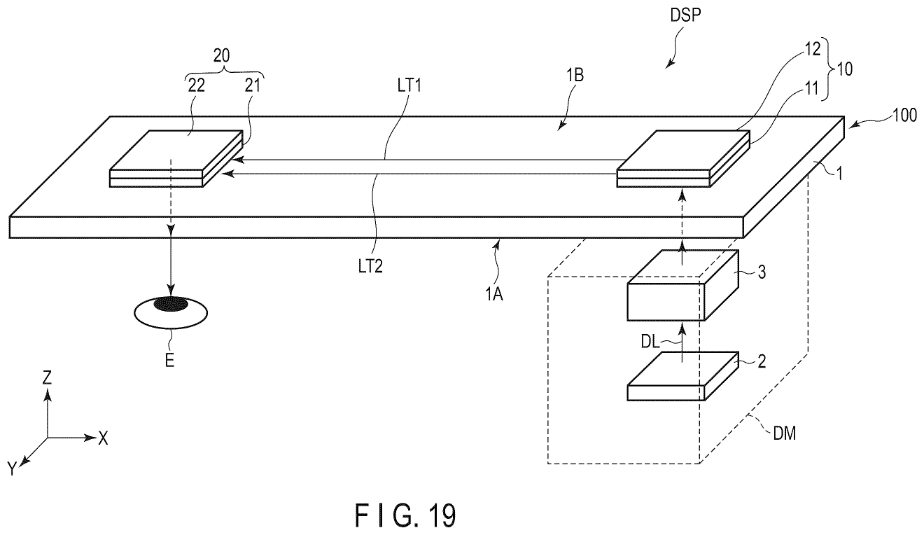

FIG. 19 is a view showing another configuration example of the display device DSP.

The configuration example shown in FIG. 19 differs from the configuration example shown in FIG. 15 in that the second optical element 20 is configured as a stacked layer body of the liquid crystal layers 21 and 22. In the same manner as in the configuration example shown in FIG. 15, the first optical element 10 is formed as a stacked layer body of the liquid crystal layers 11 and 12.

As described with reference to FIG. 3, the liquid crystal layer 21 contains the cholesteric liquid crystal CL1. Further, as described with reference to FIG. 4, the liquid crystal layer 22 contains the cholesteric liquid crystal CL2.

However, in the first optical element 10, the reflective surface 11R of the liquid crystal layer 11 and the reflective surface 12R of the liquid crystal layer 12 have the same shape as the one shown in FIG. 16. However, in the second optical element 20, the reflective surface 21R of the liquid crystal layer 21 and the reflective surface 22R of the liquid crystal layer 22 have the same shape as the one shown in FIG. 17.

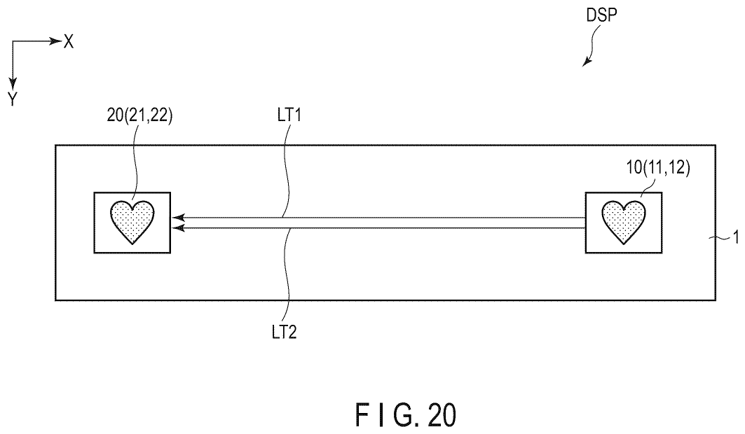

FIG. 20 is a plan view showing an example of an image displayed in the display device DSP shown in FIG. 19.

For example, when a heart-shaped image is displayed in the display element 2 shown in FIG. 19, the display light DL emitted from the display element 2 is reflected in the liquid crystal layer 11 of the first optical element 10 toward the liquid crystal layer 21 of the second optical element 20, and is reflected in the liquid crystal layer 12 toward the liquid crystal layer 22 of the second optical element 20. Each of the light LT1 reflected at the liquid crystal layer 11 and the light LT2 reflected at the liquid crystal layer 12 propagates through the transparent substrate 1 along the first direction X. Thus, the light LT1 is reflected at the liquid crystal layer 21. Further, the light LT2 is reflected in the liquid crystal layer 22 toward the same position as that of the light LT1.

As shown in FIG. 19, when the eye E faces the second optical element 20, the user can visually recognize the heart-shaped image as the light LT1 and the light LT2. That is, an image with a higher resolution than those in the configuration examples can be displayed.

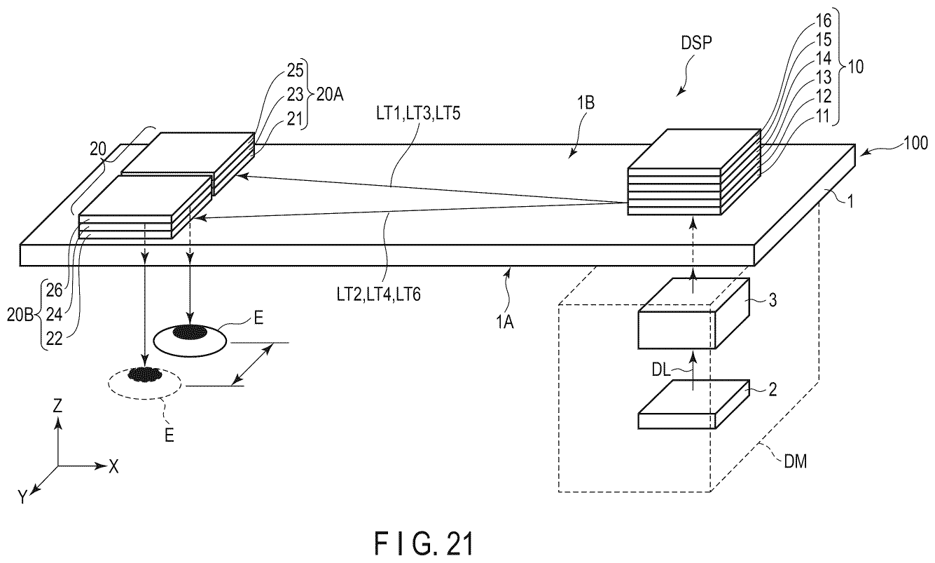

FIG. 21 is a view showing another configuration example of the display device DSP.

The configuration example shown in FIG. 21 differs from the configuration example shown in FIG. 1 in that the display device DSP is configured to enable multicolor display.

In addition to the liquid crystal layers 11 and 12, the first optical element 10 comprises liquid crystal layers 13, 14, 15, and 16. In the illustrated example, the liquid crystal layer 11, the liquid crystal layer 12, the liquid crystal layer 13, the liquid crystal layer 14, the liquid crystal layer 15, and the liquid crystal layer 16 are stacked in this order along the third direction Z.

In addition to the liquid crystal layers 21 and 22, the second optical element 20 comprises liquid crystal layers 23, 24, 25, and 26. The liquid crystal layer 21, the liquid crystal layer 23, and the liquid crystal layer 25 are stacked in this order along the third direction Z to constitute the first stacked layer body 20A. The liquid crystal layer 22, the liquid crystal layer 24, and the liquid crystal layer 26 are stacked in this order along the third direction Z to constitute the second stacked layer body 20B. These first stacked layer body 20A and second stacked layer body 20B are arranged in the second direction Y.

The stacking order of a plurality of liquid crystal layers in the first optical element 10 and the second optical element 20 is not limited to the illustrated example.

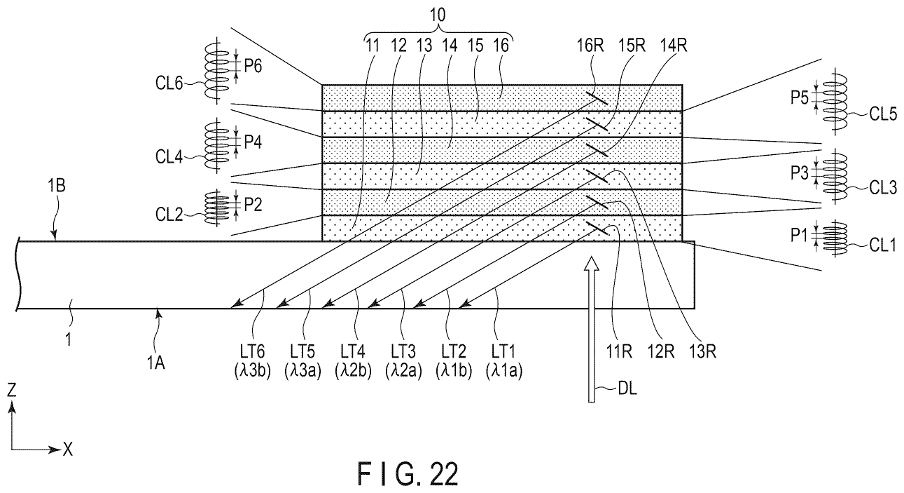

FIG. 22 is a view for describing the first optical element 10 of the display device DSP shown in FIG. 21.

As shown enlarged and schematically, the liquid crystal layers 11, 12, 13, 14, 15, and 16 contains the respective cholesteric liquid crystals CL1, CL2, CL3, CL4, CL5, and CL6.

The cholesteric liquid crystal CL1 has the helical pitch P1 along the third direction Z. The liquid crystal layer 11 has the reflective surface 11R.

The cholesteric liquid crystal CL2 is twisted in the opposite direction to the cholesteric liquid crystal CL1 and has the helical pitch P2 along the third direction Z. The helical pitches P1 and P2 are equivalent to each other. The liquid crystal layer 12 has the reflective surface 12R.

The cholesteric liquid crystal CL3 has a helical pitch P3 along the third direction Z. The helical pitch P3 differs from the helical pitch P1. The liquid crystal layer 13 has a reflective surface 13R.

The cholesteric liquid crystal CL4 is twisted in the opposite direction to the cholesteric liquid crystal CL3 and has a helical pitch P4 along the third direction Z. The helical pitches P4 and P3 are equivalent to each other. The liquid crystal layer 14 has a reflective surface 14R.

The cholesteric liquid crystal CL5 has a helical pitch P5 along the third direction Z. The helical pitch P5 differs from both of the helical pitches P1 and P3. The liquid crystal layer 15 has a reflective surface 15R.

The cholesteric liquid crystal CL6 is twisted in the opposite direction to the cholesteric liquid crystal CL5 and has a helical pitch P6 along the third direction Z. The helical pitches P6 and P5 are equivalent to each other. The liquid crystal layer 16 has a reflective surface 16R.

In the illustrated example, the helical pitch P3 is greater than the helical pitch P1, and the helical pitch P5 is greater than the helical pitch P3.

The reflective surfaces 11R and 12R are configured to reflect light in the same first wavelength band λ1 as the selective reflection band. For example, the light LT1 reflected at the reflective surface 11R is right-handed circularly polarized light λ1a in the first wavelength band λ1. Further, the light LT2 reflected at the reflective surface 12R is left-handed circularly polarized light λ1b in the first wavelength band λ1.

The reflective surfaces 13R and 14R are configured to reflect light in the same second wavelength band λ2 as the selective reflection band. The second wavelength λ2 is in a longer wavelength band than the first wavelength λ1. For example, the light LT3 reflected at the reflective surface 13R is right-handed circularly polarized light λ2a in the second wavelength band λ2. Further, the light LT4 reflected at the reflective surface 14R is left-handed circularly polarized light λ2b in the second wavelength band λ2.

The reflective surfaces 15R and 16R are configured to reflect light in the same third wavelength band λ3 as the selective reflection band. The third wavelength λ3 is in a longer wavelength band than the second wavelength λ2. For example, the light LT5 reflected at the reflective surface 15R is right-handed circularly polarized light λ3a in the third wavelength band λ3. Further, the light LT6 reflected at the reflective surface 16R is left-handed circularly polarized light λ3b in the third wavelength band λ3.

The liquid crystal layers 11, 13, and 15 are configured to reflect the display light DL toward the first stacked layer body 20A. Each of the light LT1, the light LT3, and the light LT5 undergoes total reflection at the first main surface 1A and the second main surface 1B in the transparent substrate 1, propagates in directions different from the first direction X and the second direction Y, and then propagates toward the first stacked layer body 20A as shown in FIG. 21.

The liquid crystal layers 12, 14, and 16 are configured to reflect the display light DL toward the second stacked layer body 20B. Each of the light LT2, the light LT4, and the light LT6 undergoes total reflection at the first main surface 1A and the second main surface 1B in the transparent substrate 1, propagates in directions different from the first direction X and the second direction Y, and then propagates toward the second stacked layer body 20B as shown in FIG. 21.

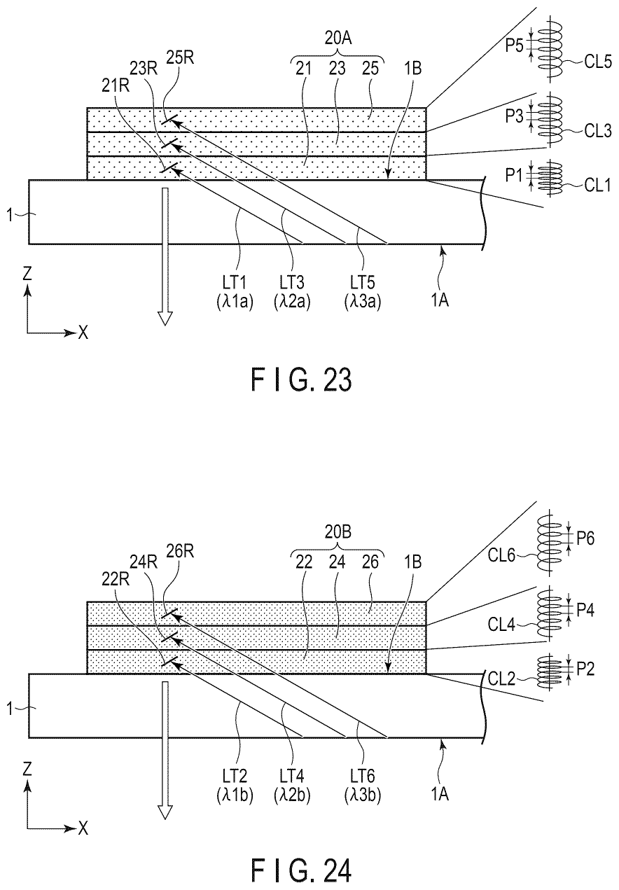

FIG. 23 is a view for describing the first stacked layer body 20A of the display device DSP shown in FIG. 21.

As shown schematically and enlarged, the liquid crystal layers 21, 23, and 25 contain the respective cholesteric liquid crystals CL1, CL3, and CL5. That is, the liquid crystal layer 21 has the same configuration as the liquid crystal layer 11. The liquid crystal layer 23 has the same configuration as the liquid crystal layer 13. The liquid crystal layer 25 has the same configuration as the liquid crystal layer 15.

The liquid crystal layer 21 has the reflective surface 21R reflecting the light LT1 reflected at the liquid crystal layer 11. The light LT1 reflected at the reflective surface 21R is right-handed circularly polarized light λ1a in the first wavelength band λ1. The liquid crystal layer 21 is configured to reflect the light LT1 along the normal to the second main surface 1B.

The liquid crystal layer 23 has a reflective surface 23R reflecting the light LT3 reflected at the liquid crystal layer 13. The light LT3 reflected at the reflective surface 23R is right-handed circularly polarized light λ2a in the second wavelength band λ2. The liquid crystal layer 23 is configured to reflect the light LT3 along the normal to the second main surface 1B.

The liquid crystal layer 25 has a reflective surface 25R reflecting the light LT5 reflected at the liquid crystal layer 15. The light LT5 reflected at the reflective surface 25R is right-handed circularly polarized light λ3a in the third wavelength band λ3. The liquid crystal layer 25 is configured to reflect the light LT5 along the normal to the second main surface 1B.

When the eye E of a user faces the first stacked layer body 20A in the third direction Z, the user can visually recognize the light LT1 in the first wavelength λ1, the light LT3 in the second wavelength λ2, and the light LT5 in the third wavelength band λ3.

FIG. 24 is a view for describing the second stacked layer body 20B of the display device DSP shown in FIG. 21.

As shown schematically and enlarged, the liquid crystal layers 22, 24, and 26 contain the respective cholesteric liquid crystals CL2, CL4, and CL6. That is, the liquid crystal layer 22 has the same configuration as the liquid crystal layer 12. The liquid crystal layer 24 has the same configuration as the liquid crystal layer 14. The liquid crystal layer 26 has the same configuration as the liquid crystal layer 16.

The liquid crystal layer 22 has the reflective surface 22R reflecting the light LT2 reflected at the liquid crystal layer 12. Further, the light LT2 reflected at the reflective surface 22R is left-handed circularly polarized light λ1b in the first wavelength band λ1. The liquid crystal layer 22 is configured to reflect the light LT2 along the normal to the second main surface 1B.

The liquid crystal layer 24 has a reflective surface 24R reflecting the light LT4 reflected at the liquid crystal layer 14. Further, the light LT4 reflected at the reflective surface 24R is left-handed circularly polarized light λ2b in the second wavelength band λ2. The liquid crystal layer 24 is configured to reflect the light LT4 along the normal to the second main surface 1B.

The liquid crystal layer 26 has a reflective surface 26R reflecting the light LT6 reflected at the liquid crystal layer 16. Further, the light LT6 reflected at the reflective surface 26R is left-handed circularly polarized light λ3b in the third wavelength band λ3. The liquid crystal layer 26 is configured to reflect the light LT6 along the normal to the second main surface 1B.

When the eye E of a user faces the first stacked layer body 20B in the third direction Z, the user can visually recognize the light LT2 in the first wavelength λ1, the light LT4 in the second wavelength λ2, and the light LT6 in the third wavelength band λ3.

As shown in FIG. 21, in the display device DSP, an image displayed in the display element 2 is divided into two parts. These two parts are displayed as a multicolor image and aligned in the second direction Y. Thus, even when a plurality of users with different positions of eyes E use the display device DSP, each user can visually recognize the display light DL at the optimal location corresponding to their positions of the eyes E. In this manner, the reduction in the visibility of multicolor images can be prevented without giving each user uncomfortable feeling.

In this manner, in the configuration example described with reference to FIG. 21 to FIG. 24, the liquid crystal layer 11 corresponds to the first liquid crystal layer of the first optical element 10. The liquid crystal layer 12 corresponds to the second liquid crystal layer of the first optical element 10. The liquid crystal layer 13 corresponds to the third liquid crystal layer of the first optical element 10. The liquid crystal layer 14 corresponds to the fourth liquid crystal layer of the first optical element 10. The liquid crystal layer 15 corresponds to the fifth liquid crystal layer of the first optical element 10. The liquid crystal layer 16 corresponds to the sixth liquid crystal layer of the first optical element 10.

The liquid crystal layer 21 corresponds to the first liquid crystal layer of the second optical element 20. The liquid crystal layer 22 corresponds to the second liquid crystal layer of the second optical element 20. The liquid crystal layer 23 corresponds to the third liquid crystal layer of the second optical element 20. The liquid crystal layer 24 corresponds to the fourth liquid crystal layer of the second optical element 20. The liquid crystal layer 25 corresponds to the fifth liquid crystal layer of the second optical element 20. The liquid crystal layer 26 corresponds to the sixth liquid crystal layer of the second optical element 20.

The cholesteric liquid crystal CL1 corresponds to the first cholesteric liquid crystal. The cholesteric liquid crystal CL2 corresponds to the second cholesteric liquid crystal. The cholesteric liquid crystal CL3 corresponds to the third cholesteric liquid crystal. The cholesteric liquid crystal CL4 corresponds to the fourth cholesteric liquid crystal. The cholesteric liquid crystal CL5 corresponds to the fifth cholesteric liquid crystal. The cholesteric liquid crystal CL6 corresponds to the sixth cholesteric liquid crystal. The helical pitches P1 and P2 correspond to the first helical pitches. The helical pitches P3 and P4 correspond to the second helical pitches. The helical pitches P5 and P6 correspond to the third helical pitches.

As explained above, the embodiment can provide a display device and a light guide element such that the reduction in the visibility of images can be prevented.

While certain embodiments of the present disclosure have been described, these embodiments have been presented by way of example only, and are not intended to limit the scope of the disclosure. Indeed, the novel embodiments described herein may be embodied in a variety of other forms; furthermore, various omissions, substitutions and changes in the form of the embodiments described herein may be made without departing from the spirit of the disclosure. The accompanying claims and their equivalents are intended to cover such forms or modifications as would fall within the scope and spirit of the disclosure.

What is claimed is

1. A display device, comprising:
a transparent substrate having a first main surface and a second main surface on a side opposite to the first main surface;
a display element facing the first main surface and configured to emit display light toward the transparent substrate;
a first optical element facing the display element via the transparent substrate, provided on the second main surface, and configured to reflect the display light passed through the transparent substrate; and
a second optical element spaced apart from the first optical element, provided on the second main surface, and configured to reflect the display light propagated inside the transparent substrate, wherein
each of the first optical element and the second optical element comprises:
a first liquid crystal layer containing a first cholesteric liquid crystal; and
a second liquid crystal layer containing a second cholesteric liquid crystal twisted in an opposite direction to the first cholesteric liquid crystal, wherein
the second liquid crystal layer overlaps the first liquid crystal layer in the first optical element, and
the first liquid crystal layer and the second liquid crystal layer are arranged on the second main surface in the second optical element.

2. The display device of claim 1, wherein
the first cholesteric liquid crystal and the second cholesteric liquid crystal each have an equivalent first helical pitch.

3. The display device of claim 1, wherein
the first liquid crystal layer of the second optical element is configured to reflect display light reflected at the first liquid crystal layer of the first optical element, along a normal to the second main surface, and
the second liquid crystal layer of the second optical element is configured to reflect display light reflected at the second liquid crystal layer of the first optical element, along the normal to the second main surface.

4. The display device of claim 1, wherein
the first optical element and the second optical element are arranged at a distance in a first direction, and
in the second optical element, the first liquid crystal layer and the second liquid crystal layer are arranged in a second direction intersecting the first direction.

5. The display device of claim 4, wherein
in each of the first optical element and the second optical element,
the first liquid crystal layer has a first reflective surface inclined with respect to the second main surface,
the second liquid crystal layer has a second reflective surface inclined with respect to the second main surface, and
the first reflective surface and the second reflective surface are not parallel to each other.

6. The display device of claim 1, wherein
the first liquid crystal layer in the second optical element is thinner than the first liquid crystal layer in the first optical element, and
the second liquid crystal layer in the second optical element is thinner than the second liquid crystal layer in the first optical element.

7. The display device of claim 4, wherein
the second optical element further comprises:
a third liquid crystal layer containing a third cholesteric liquid crystal equivalent to the first cholesteric liquid crystal; and
a fourth liquid crystal layer containing a fourth cholesteric liquid crystal equivalent to the second cholesteric liquid crystal, and
in the second optical element, the first liquid crystal layer and the third liquid crystal layer are arranged in the first direction, and the second liquid crystal layer and the fourth liquid crystal layer are arranged in the first direction.

8. The display device of claim 7, wherein
the first liquid crystal layer is thicker than the third liquid crystal layer, and
the second liquid crystal layer is thicker than the fourth liquid crystal layer.

9. The display device of claim 1, wherein
the first optical element and the second optical element are arranged at a distance in a first direction, and
in the second optical element, the first liquid crystal layer and the second liquid crystal layer are arranged in the first direction.

10. The display device of claim 9, wherein
the first liquid crystal layer and the second liquid crystal layer each have an equivalent thickness.

11. The display device of claim 9, wherein
in each of the first optical element and the second optical element,
the first liquid crystal layer has a first reflective surface inclined with respect to the second main surface,
the second liquid crystal layer has a second reflective surface inclined with respect to the second main surface, and
the first reflective surface and the second reflective surface are parallel to each other.

12. The display device of claim 1, wherein
each of the first optical element and the second optical element further comprises:
a third liquid crystal layer containing a third cholesteric liquid crystal;
a fourth liquid crystal layer containing a fourth cholesteric liquid crystal twisted in an opposite direction to the third cholesteric liquid crystal;
a fifth liquid crystal layer containing a fifth cholesteric liquid crystal; and
a sixth liquid crystal layer containing a sixth cholesteric liquid crystal twisted in an opposite direction to the fifth cholesteric liquid crystal,
the first cholesteric liquid crystal and the second cholesteric liquid crystal each have an equivalent first helical pitch,
the third cholesteric liquid crystal and the fourth cholesteric liquid crystal each have an equivalent second helical pitch,
the fifth cholesteric liquid crystal and the sixth cholesteric liquid crystal each have an equivalent third helical pitch,
the first helical pitch, the second helical pitch, and the third helical pitch differ from each other,
the first optical element is a stacked layer body of the first liquid crystal layer, the second liquid crystal layer, the third liquid crystal layer, the fourth liquid crystal layer, the fifth liquid crystal layer, and the sixth liquid crystal layer, and
the second optical element comprises a first stacked layer body of the first liquid crystal layer, the third liquid crystal layer, and the fifth liquid crystal layer, and a second stacked layer body of the second liquid crystal layer, the fourth liquid crystal layer, and the sixth liquid crystal layer.

13. The display device of claim 12, wherein
in the first optical element,
the first liquid crystal layer, the third liquid crystal layer, and the fifth liquid crystal layer are configured to reflect display light toward the first stacked layer body, and
the second liquid crystal layer, the fourth liquid crystal layer, and the sixth liquid crystal layer are configured to reflect display light toward the second stacked layer body.

14. The display device of claim 13, wherein
in the second optical element, each of the first liquid crystal layer, the second liquid crystal layer, the third liquid crystal layer, the fourth liquid crystal layer, the fifth liquid crystal layer, and the sixth liquid crystal layer is configured to reflect display light propagated inside the transparent substrate, along a normal to the second main surface.
